(19) United States
(12) Patent Application Publication
(10) Pub. No.: US 2023/0051550 A1
(43) Pub. Date: Feb. 16, 2023

(54) Adhesive, Bonded Body, and Method for Producing Press-Bonded Body

(71) Applicants: Valqua, Ltd., Tokyo (JP); National Institute of Advanced Industrial Science and Technology, Tokyo (JP)

(72) Inventors: Yoshihiro Setoguchi, Machida-shi, Tokyo (JP); Naoki Watanabe, Machida-shi, Tokyo (JP); Takafumi Aizawa, Sendai-shi (JP)

(21) Appl. No.: 17/788,658

(22) PCT Filed: Dec. 15, 2020
(86) PCT No.: PCT/JP2020/046719

§ 371 Date: Jun. 23, 2022

(30) Foreign Application Priority Data
Dec. 24, 2019 (JP) 2019-233100

(51) Int. Cl. C09J 127/12

(52) U.S. Cl. CPC C09J 127/12

(57) ABSTRACT

An embodiment of the present invention relates to an adhesive, a bonded body or a method for producing a press-bonded body. The adhesive includes a fluoroelastomer and is for bonding base materials in the presence of carbon dioxide in a liquid state, a gas-liquid mixture state, or a nearly liquid state. The bonded body is such that two or more base materials are bonded to each other with the adhesive. The method for producing a press-bonded body includes a step 1 in which two or more base materials are press-bonded in the presence of the adhesive including a fluoroelastomer and carbon dioxide in a liquid state, a gas-liquid mixture state, or a nearly liquid state.

### CROSS-REFERENCE TO RELATED APPLICATIONS

This application is the U.S. national phase of International Application No. PCT/JP2020/046719 filed Dec. 15, 2020, and claims priority to Japanese Patent Application No. 2019-233100 filed Dec. 24, 2019, the disclosures of which are hereby incorporated by reference in their entirety.

### BACKGROUND OF THE INVENTION

### Field of the Invention

An embodiment of the present invention relates to an adhesive, a bonded body, or a method for producing a press-bonded body.

### Description of Related Art

Base materials such as non-woven fabric, woven fabric, fiber, porous membrane, and film may be used alone or in lamination with a plurality of the same base materials or other base materials.

When using such base materials by laminating them, base materials are ordinarily bonded to each other by a method using an adhesive that includes reacting a component in the adhesive or volatilizing a solvent in the adhesive, or by a method that includes melting an adhesive layer or the base materials themselves to cause heat sealing.

The method of bonding base materials with an adhesive has an advantage for example of being capable of bonding base materials in a simple and easy manner. With respect to the obtained bonded bodies, however, adhesive portions may have problematic heat resistance or may cause foreign matter inclusion or contamination, and there is a room for improvement on these points.

In contrast, the method for bonding base materials by heat sealing has an advantage for example of being capable of obtaining a bonded body with high adhesive strength. However, there is a room for improvement since the freedom in selecting base materials is restricted due to heat resistance, or there is damage (or loss) of the shapes or physical properties of base materials before heat sealing, specifically for example the shape of base materials before heat sealing such as voids, and the functions of a functional material included in base materials before heat sealing, and the functions of base materials before heat sealing which have been achieved by treatments such as surface treatment.

In addition, the method for bonding base materials by heat sealing also has a room for improvement in respect of energy cost.

As a method for solving the above problems involved in conventional bonding methods, Patent Literature JP 2018-099885 A discloses a method of bonding a fibrous resin in the presence of carbon dioxide in a liquid state, a gas-liquid mixture state, or a nearly liquid state.

### SUMMARY OF INVENTION

### Technical Problem

Since fluorine materials particularly have excellent chemical resistance and are non-adhesive, the above Patent Literature JP 2018-099885 A does not disclose a method for bonding base materials using such fluorine material concerning the method described therein.

An embodiment of the present invention provides an adhesive using a fluoroelastomer, which is capable of forming a bonded body in an intended shape having base materials which hardly peel off from each other.

### Solution to Problem

As a result of earnest study to solve the above problem, the present inventors found that configuration examples as described below can solve the above problem.

The configuration examples of the present invention are as described below.

[1] An adhesive including a fluoroelastomer for bonding base materials in the presence of carbon dioxide in a liquid state, a gas-liquid mixture state, or a nearly liquid state.

[2] The adhesive described in [1] for bonding at a temperature lower than a temperature at which the adhesive melts.

[3] The adhesive described in [1] or [2], in which the fluoroelastomer is at least one selected from tetrafluoroethylene-perfluorovinylether copolymers and fluorine rubber.

[4] A bonded body in which two or more base materials are bonded to each other with the adhesive described in any one of [1] to [3].

[5] The bonded body described in [4], in which at least one of the base materials is a non-woven fabric, a woven fabric, a porous membrane, or a fiber.

[6] A method for producing a press-bonded body, including a step 1 of
press-bonding two or more base materials
in the presence of an adhesive including a fluoroelastomer, and
carbon dioxide in a liquid state, a gas-liquid mixture state, or a nearly liquid state.

[7] The method for producing a press-bonded body described in [6], in which the step 1 is
a step 1a in which a laminate in which an adhesive layer obtained from the adhesive is arranged between the base materials is brought into contact with liquid or gaseous carbon dioxide and is pressurized, or
a step 1b in which a contact body in which the base materials are brought into contact with the adhesive, or a dried body in which said contact body is dried is brought into contact with liquid or gaseous carbon dioxide and is pressurized.

### Advantageous Effects of Invention

According to an embodiment of the present invention, a bonded body in an intended shape, having base materials which hardly peel off from each other can be obtained using a fluoroelastomer.

Moreover, according to an embodiment of the present invention, the obtained bonded body has excellent chemical resistance in an adhesive portion from which foreign matter inclusion or contamination is hardly caused, has high freedom in the selection of base materials, or is capable of maintaining the shape or physical properties of base materials before bonding.

Furthermore, according to an embodiment of the present invention, a bonded body can be formed without applying heat from the outside. Thus, a bonded body can be produced at low energy cost, and the obtained bonded body also has an advantage of being easy to secondarily process.

### BRIEF DESCRIPTION OF DRAWINGS

FIG. 1 shows the peel strength of a press-bonded body (laminate) obtained in Example 1.

FIG. 2 The left side of FIG. 2 is an SEM image of a surface of a sample used in Example 3, the center of FIG. 2 is an SEM image of a surface of a laminate for comparison obtained in Example 3, and the right side of FIG. 2 is an SEM image of a surface of a press-bonded body obtained in Example 3.

FIG. 3 The left side of FIG. 3 is a photograph of the appearance of a laminate (without CO₂) for comparison obtained in Example 4, and the right side of FIG. 3 is a photograph of the appearance of a press-bonded body obtained in Example 4.

FIG. 4 The left side of FIG. 4 is a photograph of the appearance of a press-bonded body obtained in Example 5, and the right side of FIG. 4 is a photograph of the appearance of the press-bonded body after immersed in water.

### DESCRIPTION OF THE INVENTION

### Adhesive

An adhesive of an embodiment of the present invention (this may be hereinafter referred to as “the present adhesive”) is used for bonding base materials in the presence of carbon dioxide in a liquid state, a gas-liquid mixture state, or a nearly liquid state, and includes a fluoroelastomer.

A reason why a bonded body exhibiting the above effects is obtainable using the present adhesive is not necessarily clarified, but it is supposed that when base materials are bonded to each other in the presence of carbon dioxide in a liquid state, a gas-liquid mixture state, or a nearly liquid state, at least part of a fluoroelastomer included in the adhesive is plasticized due to carbon dioxide, and due to effects such as an anchor effect produced by the plasticization, the base materials can be bonded and linked by fixing the shape in a state in which the base materials are engaged.

According to an embodiment of the present invention, a bonded body can be formed without heating from the outside. Thus, the present adhesive is preferably an adhesive used for bonding base materials at a temperature lower than the melting points of the base materials and the adhesive, more preferably an adhesive used for bonding base materials at a temperature of approximately 50° C. or lower, and particularly preferably an adhesive used for bonding base materials without heating from the outside.

The present adhesive may be an adhesive used for bonding base materials in the presence of carbon dioxide in a liquid state, a gas-liquid mixture state, or a nearly liquid state. During the bonding, carbon dioxide in a subcritical state or a supercritical state may be present. However, carbon dioxide in a subcritical state or a supercritical state is preferably absent from the viewpoints for example that press force is reducible and that bonding is performable without a device having systems such as a heating system.

The “carbon dioxide in a nearly liquid state” is specifically carbon dioxide in a state in which the density is 0.4 g/mL (approximately half the density of carbon dioxide in a liquid state) or greater.

### Fluoroelastomer

The fluoroelastomer is not particularly limited and is preferably at least one type selected from tetrafluoroethylene (TFE)-perfluorovinylether copolymers (FFKM) and fluorine rubber (FKM).

The present adhesive may include two or more types of fluoroelastomers.

The FFKM is preferably a copolymer including a constituent unit derived from TFE and a constituent unit derived from perfluorovinylether, and if needed, a constituent unit derived from a monomer having a crosslinking moiety.

Preferred examples of the perfluorovinylether are a perfluoro(alkylvinylether) and a perfluoro(alkoxyalkylvinylether).

Examples of the perfluoro(alkylvinylether) are compounds including an alkyl group having 1 to 10 carbon atoms, which are specifically exemplified by perfluoro(methylvinylether), perfluoro(ethylvinylether), and perfluoro(propylvinylether). Perfluoro(methylvinylether) is, however, preferred.

Examples of the perfluoro(alkoxyalkylvinylether) are compounds in which a group bonding to a vinylether group (CF₂═CFO—) has for example 3 to 15 carbon atoms, which are specifically exemplified by
CF₂═CFOCF₂CF(CF₃)OCₙF₂ₙ₊₁,
CF₂═CFO(CF₂)₃OCₙF₂ₙ₊₁,
CF₂═CFOCF₂CF(CF₃)O(CF₂O)ₘCₙF₂ₙ₊₁, and
CF₂═CFO(CF₂)₂OCₙF₂ₙ₊₁.

In the above formulae, n is individually 1 to 5 and m is 1 to 3, for example.

Due to a constituent unit derived from a monomer having a crosslinking moiety included in FFKM, crosslinking properties can be imparted to FFKM. The crosslinking moiety means a moiety which is crosslinkable and is exemplified by nitrile groups, halogen groups (such as an I group and a Br group), and perfluorophenyl groups.

Examples of monomers having a crosslinking moiety which have a nitrile group as a crosslinking moiety are nitrile group-containing perfluorovinylethers, which are specifically exemplified by
CF₂═CFO(CF₂)ₙOCF(CF₃)CN (for example n is 2 to 4)
CF₂═CFO(CF₂)ₙCN (for example n is 2 to 12)
CF₂═CFO[CF₂CF(CF₃)O]ₘ(CF₂)ₙCN (for example n is 2 and m is 1 to 5)
CF₂═CFO[CF₂CF(CF₃)O]ₘ(CF₂)ₙCN (for example n is 1 to 4 and m is 1 to 2)
CF₂═CFO[CF₂CF(CF₃)O]ₙCF₂CF(CF₃)ₙCN (for example n is 0 to 4).

Examples of monomers having a crosslinking moiety which have a halogen group as a crosslinking moiety are halogen group-containing perfluorovinylethers, which are specifically exemplified by compounds equivalent to those described as the specific examples of the nitrile group-containing perfluorovinylethers in which a nitrile group is replaced with a halogen group.

In FFKM, the content of the constituent unit derived from TFE is preferably 50.0 to 79.9% by mole, the content of the constituent unit derived from perfluorovinylether is preferably 20.0 to 46.9% by mole, and the content of the constituent units derived from a monomer having a crosslinking moiety is preferably 0.1 to 2.0% by mole.

Examples of the FKM are rubbers other than the FFKM and are not particularly limited. Specific examples are vinylidene fluoride-hexafluoropropylene polymers; vinylidene fluoride-hexafluoropropylene-tetrafluoroethylene polymers; tetrafluoroethylene-propylene polymers; vinylidene fluoride-propylene-tetrafluoroethylene polymers; ethylene-tetrafluoroethylene-perfluoromethyl vinyl ether polymers; vinylidene fluoride-tetrafluoroethylene-perfluoromethyl vinyl ether polymers; and vinylidene fluoride-perfluoromethyl vinyl ether polymers.

In order to impart crosslinking properties to the FKM, the FKM may include the same constituent units derived from monomers having a crosslinking moiety as those described in the above paragraphs describing FFKM.

The fluorine content in the fluoroelastomer is preferably 60% by mass or greater, more preferably 62% by mass or greater, and particularly preferably 64% by mass or greater; and preferably 80% by mass or less, and more preferably 78% by mass or less.

When the fluorine content is within the above range, base materials can be easily bonded to each other, a bonded body in an intended shape, having base materials which hardly peel off from each other for example, can be easily obtained, and further a bonded body having excellent chemical resistance and hardly causing foreign matter inclusion or contamination from an adhesive portion can be easily obtained.

The fluorine content may be measured and calculated by the solid state nuclear magnetic resonance (NMR) method or the mass spectrometry (MS) method.

The content of a perfluoroelastomer relative to 100% by mass of components except for a solvent and a dispersion medium in the present adhesive is preferably 90 to 100% by mass, more preferably 95 to 100% by mass, and particularly preferably 98 to 100% by mass.

When the fluoroelastomer content is within the above range, base materials may be easily bonded to each other in the presence of carbon dioxide in a liquid state, a gas-liquid mixture state, or a nearly liquid state, a bonded body in an intended shape, having base materials which hardly peel off from each other for example, can be easily obtained, and further a bonded body having excellent chemical resistance and hardly causing foreign matter inclusion or contamination from an adhesive portion can be easily obtained.

In addition to the fluoroelastomer, the present adhesive may include, depending on necessity, conventionally known additives such as a crosslinking agent, a crosslinking aid, an anti-aging agent, an antioxidant, a vulcanization accelerator, a processing aid (such as stearic acid), a stabilizer, a tackifier, a silane coupling agent, functional (nano)particles, a plasticizer, a flame retardant, waxes, and a lubricant, as long as effects of the present invention are not lost.

In cases where a bonded body obtained with the present adhesive is used under high temperature circumstances, it is preferred that the amount of the above additives is reduced as much as possible due to the risk of volatilization, elution, or precipitation. Specifically, the amount is, relative to 100 parts by mass of a fluoroelastomer, preferably 10 parts by mass or less, more preferably 5 parts by mass or less, and still more preferably 2 parts by mass or less, and particularly preferably 1 part by mass or less. Further, the bonded body being free of the additives is desirable.

The present adhesive may be a solid adhesive for example in a film state, a fibrous state, a line state, a spherical (particle) state, a lattice state, or a non-woven fabric state, or a liquid adhesive in which a component such as the fluoroelastomer is dispersed or dissolved.

In other words, the present adhesive may include a solvent in which the fluoroelastomer can be dispersed or dissolved. In this case, it is preferred to include a solvent in which the fluoroelastomer can be dissolved.

The concentration of the fluoroelastomer in the liquid adhesive is preferably 0.01% by mass or greater and more preferably 0.5% by mass or greater; and preferably 20% by mass or less and more preferably 10% by mass or less.

### Base Material

Base materials to be bonded with the present adhesive are not particularly limited and are exemplified by a base material including at least one selected from resin, carbon materials, glass, and metal.

As the base material, at least one selected from non-woven fabric, woven fabric, porous membrane, and fiber is preferably used due to the easy formation of a bonded body in an intended shape, having base materials which hardly peel off from each other.

### Resin

The resin is not particularly limited and is exemplified by fluorine resin, engineering plastics, and plastics other than the above. Among them, fluorine resin and engineering plastics are preferred.

### Fluorine Resin

The fluorine resin is not particularly limited and conventionally known fluorine resin may be used. With respect to a fluoroelastomer included in the present adhesive and a fluorine resin constituting a base material, both may be identical with or different from each other and it is preferred that both are different from each other. It is more preferred that the degree of crystallinity in the fluorine resin constituting a base material is higher than that in the fluoroelastomer included in the present adhesive.

Specific examples of the fluorine resin are a polytetrafluoroethylene (PTFE), a tetrafluoroethylene-perfluoroalkyl vinyl ether copolymer (PFA), a tetrafluoroethylene-hexafluoropropylene copolymer (FEP), an ethylene-tetrafluoroethylene copolymer (ETFE), a tetrafluoroethylene-hexafluoropropylene-perfluoroalkyl vinyl ether copolymer (EPE), a fluoroethylene-vinyl ether copolymer (FEVE), a poly(chlorotrifluoroethylene) (PCTFE), an ethylene-chlorotrifluoroethylene copolymer (ECTFE), a polyvinylidene fluoride (PVDF), a polyvinyl fluoride (PVF), a vinylidene fluoride-hexafluoropropylene copolymer (VDF-HFP copolymer), and a vinylidene fluoride-hexafluoropropylene-tetrafluoroethylene copolymer (VDF-HFP-TFE copolymer). Among these fluorine resins, PTFE and PFA are preferred.

### Engineering Plastics

The engineering plastics are not particularly limited and conventionally known engineering plastics may be used. Specific examples are polyphenylene sulfide resin (PPS), polysulfone resin, polyether sulfone resin, polyether ether ketone resin (PEEK), polyarylate resin, liquid crystal polymers, aromatic polyester resin, polyimide resin, polyamide imide resin, polyether imide resin, aramid resin, polycarbonate resin, polyacetal resin, polyester resins such as polyethylene terephthalate (PET), polybutylene terephthalate (PBT), and polycyclohexylene dimethyl terephthalate (PCT), polyphenylene ether resin, polyphenylene oxide resin, polyamide resins such as nylon 6, nylon 66, and aromatic polyamides, acrylic polymers, vinyl chloride polymers, vinylidene chloride polymers, polybenzoazole resin (such as polybenzimidazole (PBI)), and olefin resins such as polyethylene (such as ultrahigh molecular weight polyethylene) and polypropylene (such as ultrahigh molecular weight polypropylene).

### Other Plastics

The other plastics described above are not particularly limited as long as being resins other than fluorine resin and engineering plastics, and conventionally known plastics may be used. Specific examples are polyvinyl chloride (PVC), polystyrene (PS), acrylonitrile-butadiene-styrene resin (ABS), polymethylmethacrylate resin (PMMA), and thermosetting resins such as phenolic resins (including straight phenolic resin and various types of modified phenolic resins), melamine resins, and epoxy resins.

Base materials including the above resins may also include other components such as fibers exemplified by carbon fiber and glass fiber, and the additives as those described in the above paragraphs describing the adhesive.

The shapes of base materials including the above resins are exemplified by fiber, porous membrane (including stretched porous membrane), non-woven fabric, woven fabric, and film.

When a resin-including film is used as the above base material, a film in which a surface contacting with the present adhesive is roughened by a conventionally known method is preferably used on the point for example that a bonded body having base materials which hardly peel off from each other is obtainable. In addition, due to difficulty in bonding resin-including films, when a resin-including film is used as the above base material, a base material to be bonded to the film is preferably a carbon dioxide-permeable base material such as a fiber, a porous membrane, a non-woven fabric, or a woven fabric.

### Carbon Material

Base materials including the carbon materials are exemplified by carbon fibers, carbon nanotubes, and graphite sheets. The shapes of the carbon fibers are not particularly limited and are exemplified by fiber, filaments, cloth, felt, mats, paper, and prepreg.

### Glass

Examples of base materials including the glass are glass fiber, glass woven fabric, and glass non-woven fabric, which are specifically exemplified by glass cloth, glass paper, glass mats, glass felt, and these base materials having the resin described above on their surfaces.

### Metal

Examples of base materials including the metal are woven fabric, non-woven fabric, and metal fiber (including wool-like metal). Examples of base materials including the metal may also be base materials in which a support such as fiber, a porous membrane, a non-woven fabric, or a woven fabric is treated with a metal (such as base materials in which a support is plated, and base materials in which a support is sputtered with a metal).

The metals are exemplified by stainless steel, aluminum, aluminum alloys, nickel, nickel alloys, titanium, titanium alloys, copper, copper alloys, gold, gold alloys, silver, silver alloys, tantalum, tantalum alloys, chromium, chromium alloys, molybdenum, molybdenum alloys, tungsten, and tungsten alloys.

As the base materials, base materials consisting of fluorine resin are preferred and a base material consisting of PTFE or PFA, for example, is more preferred since a bonded body excelling in mechanical strength, heat resistance, chemical resistance, weatherability, and electrical insulating properties, in which all the components constituting the bonded body are fluorine components, can be easily obtained, for example.

A bonded body in an intended shape, having base materials which hardly peel off from each other, cannot have been conventionally obtained when all the components constituting the bonded body are fluorine components, which are non-adhesive and have small coefficient of friction. According to an embodiment of the present invention, however, a bonded body in an intended shape, having base materials which hardly peel off from each other, can be easily obtained even when the bonded body consists of such fluorine components.

The non-woven fabric, woven fabric, porous membrane, fiber (tubes) and film (sheets) are not particularly limited and conventionally known non-woven fabric, woven fabric, porous membrane, fiber (tubes) and film (sheets) may be used.

The base material may also be a base material having been subjected to a functionalizing treatment such as a conventionally known surface treatment, for example a hydrophilization treatment. According to an embodiment of the present invention, even when a base material having been subjected to a treatment such as the above functionalizing treatment is used, a bonded body can be formed without losing the function.

The average fiber diameter of fibers constituting the non-woven fabric or woven fabric and the fibers as well is preferably 0.01 μm or greater, more preferably 0.1 μm or greater, and still more preferably 0.5 μm or greater; and preferably 100 μm or less, more preferably 50 μm or less, and still more preferably 20 μm or less.

When the average fiber diameter is within the above range, a bonded body in an intended shape, exhibiting excellent mechanical strength and having fibers which hardly fray and base materials which hardly peel off from each other, can be easily obtained.

The average fiber diameter is an average value calculated based on the results of measurement in which fibers (a fiber group) to be measured are observed with a scanning electron microscope (SEM) (magnification: 2,000-fold), 20 fibers are randomly selected from an obtained SEM image, and the fiber diameter (major axis) of each fiber is measured.

With respect to fibers constituting the non-woven fabric or woven fabric and the fibers, the coefficient of variation of fiber diameter calculated by the formula below is preferably 0.7 or less, more preferably 0.01 or greater, and more preferably 0.5 or less. When the coefficient of variation of fiber diameter is within the above range, uniform fiber diameters are achieved, enabling the easy obtainment of a bonded body in an intended shape, exhibiting excellent mechanical strength and having fibers which hardly fray and base materials which hardly peel off from each other for example.

Coefficient of variation of fiber diameter=standard deviation/average fiber diameter

(“Standard deviation” is a standard deviation of the fiber diameters of the 20 fibers.)

With respect to fibers constituting the non-woven fabric or woven fabric and the fibers, fiber length is not particularly limited and is preferably 0.5 mm or greater, and more preferably 1 mm or greater; and preferably 100 mm or less, and more preferably 50 mm or less.

The stretched porous film is not particularly limited and may be a uniaxially stretched porous film or a biaxially stretched porous film.

The percentage of voids or porosity of the non-woven fabric, woven fabric, or porous membrane is not particularly limited and is for example 0.1% by volume or greater, and preferably 30% by volume or greater; and for example 95% by volume or less, and preferably 90% by volume or less.

The percentage of voids or porosity is calculatable by the formula below from the difference between a theoretical volume and an actual volume. The theoretical volume is calculated from a specific gravity of a material constituting a non-woven fabric, a woven fabric, or a porous membrane, and an actual mass of the non-woven fabric, the woven fabric, or the porous membrane, on the assumption that therein voids or pores are not present. The actual volume is calculated by measuring the dimensions of the non-woven fabric, the woven fabric, or the porous membrane.

Percentage of voids or porosity (% by volume)=(1−(theoretical volume/actual volume))×100

The basis weight of the non-woven fabric, the woven fabric, or the porous membrane is preferably 100 g/m² or less, more preferably 1 g/m² or greater, and more preferably 80 g/m² or less.

The thickness of the non-woven fabric, the woven fabric, the porous membrane, or the film (sheets) is ordinarily 5 μm or greater, and preferably 10 μm or greater; and ordinarily 1 mm or less, and preferably 500 μm or less.

### Bonded Body (Press-Bonded Body)

A bonded body according to an embodiment of the present invention is a bonded body in which two or more base materials are bonded to each other with the present adhesive, preferably a press-bonded body in which two or more base materials are press-bonded with the present adhesive, and more preferably a press-bonded body obtained by a method for producing a press-bonded body described below.

Base materials used for the bonded body may be two or more. In this case, two or more types of base materials having different materials or shapes may be used, or two or more base materials having the same materials or shapes may also be used.

The shape and size of the bonded body are not particularly limited and may be appropriately selected depending on intended applications for example.

The thickness of the bonded body is also not particularly limited and may be appropriately selected depending on applications for which the bonded body is used. In cases of bonded bodies of non-woven fabrics or porous membranes, the thickness is ordinarily 10 μm or greater, and preferably 50 μm or greater; and ordinarily 30 mm or less, and preferably 25 mm or less.

The bonded body may be appropriately used for applications in which base materials including resin, carbon materials, glass, or metal have been used, particularly in the fields such as medical treatment, electrical equipment, and semiconductors, and specifically as filters, various types of separators, or clothes for example.

In accordance with intended applications, the bonded body may include one or more types of functional materials required for the applications. Specific examples of the functional materials are food materials, chemicals (for medicine, agriculture, and industries), pigments, adsorbents, deodorants, aromatics, insecticides, electronic device materials, enzymes, and catalysts.

The bonded bodies, when including the above functional materials, particularly including the functional materials being inferior in heat resistance, enable the obtainment of bonded bodies that make the best use of, for example, the functions and properties of the functional materials.

For example, when including functional materials such as chemicals, bonded bodies having properties such as the controlled sustained release of the chemicals can also be obtained.

### Method for Producing Press-Bonded Body

The method for producing a press-bonded body according to an embodiment of the present invention (this may also be referred to as “the present method”) has

a step 1 of press-bonding two or more base materials

in the presence of an adhesive including a fluoroelastomer, and

carbon dioxide in a liquid state, a gas-liquid mixture state, or a nearly liquid state.

The base material is preferably a base material consisting of a fluorine resin. In this case, the present method can also be regarded as a novel method for processing a base material consisting of a fluorine resin which is difficult to process.

According to the present method as such, a press-bonded body is producible at a temperature of approximately 50° C. or lower in a short time at low cost, without applying a high temperature at which components such as a resin constituting a base material are melted. In addition, since the obtained press-bonded body basically does not retain carbon dioxide, a clean press-bonded body excelling in safety, controllability, and productivity is easily obtainable, and a press-bonded body in an intended shape, exhibiting excellent mechanical strength and having base materials which hardly peel off from each other for example, is easily obtainable. Particularly, a press-bonded body is obtainable while making the best use of the properties of the base materials (e.g., functions, and voids and fiber shape in non-woven fabric).

Moreover, according to the present method, during the production of a press-bonded body comprising the functional materials used in accordance with intended applications, a press-bonded body that makes the best use of the functions and properties of the functional materials for example, is obtainable even though the functional materials have inferior heat resistance.

A reason why a press-bonded body in an intended shape, exhibiting excellent mechanical strength and having base materials which hardly peel off from each other for example, is obtainable by the present method is not necessarily clarified. However, it is supposed that when pressure is applied in the presence of carbon dioxide in a liquid state, a gas-liquid mixture state, or a nearly liquid state, a fluoroelastomer in an adhesive is plasticized due to the carbon dioxide, and by applying pressure in the plasticized state, the base materials can be bonded and linked by fixing the shape in a state in which the base materials are engaged.

### Step 1

The step 1 is not particularly limited as long as it is a step of press-bonding two or more base materials in the presence of the present adhesive and carbon dioxide in a liquid state, a gas-liquid mixture state, or a near liquid state, and in accordance with an intended application, one or more functional materials required for the application may be used during the press-bonding. Examples of the functional materials are the same as those described in the above <<Bonded body (press-bonded body)>>.

In the above step 1, base materials between which an adhesive layer obtained from the present adhesive in a film state, a fibrous state, a line state, a sphere (particle, dot) state, a lattice state, or a non-woven fabric state is arranged may be pressurized, or a contact body in which base materials are brought into contact with the present adhesive or a dried body in which the contact body is dried may be pressurized.

The former is exemplified by a method in which an adhesive layer in, for example, a film state or a fibrous state being previously formed from the present adhesive is arranged between base materials, and a pressure is applied. The latter is exemplified by a method in which base materials are immersed in the present adhesive in a liquid state or the present adhesive in a liquid state is applied onto base materials in an intended shape (such as a line state, a dot state, or a lattice state), the solvent is volatilized depending on necessity, and a pressure is applied.

The step 1 may also be a step in which a single base material is press-bonded to the present adhesive in the presence of carbon dioxide in a liquid state, a gas-liquid mixture state, or a nearly liquid state to form a preform, which is thereafter press-bonded to an intended base material to be press-bonded in the presence of carbon dioxide in a liquid state, a gas-liquid mixture state, or a nearly liquid state, using the present adhesive depending on necessity.

In the step 1, base materials are press-bonded in the presence of carbon dioxide in a liquid state, a gas-liquid mixture state, or a nearly liquid state. It is supposed that when carbon dioxide in a liquid state, a gas-liquid mixture state, or a nearly liquid state is brought into contact with a base material, a fluoroelastomer in the adhesive is impregnated with carbon dioxide and is thereby plasticized, enabling the production of a press-bonded body without heating.

In the step 1, carbon dioxide in a subcritical state or a supercritical state may be used, but carbon dioxide in a liquid state or a gas-liquid mixture state is preferred from the viewpoints for example of reducible press force and press-bonding being performable without a device having systems such as a heating system. Moreover, carbon dioxide in a gas state is supposed to barely plasticize a base material or to take a very long time to plasticize the same. Thus, carbon dioxide in a liquid state or a gas-liquid mixture state is preferred from the viewpoint for example that a base material appears to be quickly plasticizable.

Specifically, the step 1 is preferably performed by introducing liquid or gaseous carbon dioxide into a system. That is, specifically, the following step 1a or 1b is preferred as the step 1.

Step 1a: a step such that a laminate in which the adhesive layer obtained from the adhesive is arranged between base materials is brought into contact with liquid or gaseous carbon dioxide and is pressurized; or

Step 1b: a step such that a contact body in which base materials are brought into contact with the adhesive or a dried body in which the contact body is dried, is brought into contact with liquid or gaseous carbon dioxide and is pressurized.

During the introduction of liquid or gaseous carbon dioxide into a system, the order of base materials, the adhesive, and carbon dioxide introduced into the system is not particularly limited. For example, base materials and the adhesive may be introduced into a system charged with carbon dioxide, but it is preferred that carbon dioxide is introduced into a system into which base materials and the adhesive have been introduced.

When liquid carbon dioxide is introduced, a compression step for liquefaction is omittable, enabling the production of a press-bonded body taking a short amount of time, compared with the case in which gaseous carbon dioxide is introduced.

In contrast, when gaseous carbon dioxide is introduced, the process is easy and the device can be simplified by omitting a press pump, compared with the case in which liquid carbon dioxide is introduced. When gaseous carbon dioxide is introduced, carbon dioxide is ordinarily liquified by pressurizing the introduced carbon dioxide. In this case, it is sufficient that at least part of the introduced carbon dioxide, not the entirety thereof, is liquified.

The amount of carbon dioxide to be introduced is not particularly limited. When gaseous carbon dioxide is introduced and press-bonding is performed at a temperature of 31° C. (i.e., critical temperature of carbon dioxide) or higher, carbon dioxide is introduced such that the carbon dioxide density during the press-bonding is 0.4 g/mL (half the density of liquid carbon dioxide) or greater.

During the press-bonding in the step 1, surface pressure may be appropriately selected in accordance with the type and amount of a base material to be used and the intended shape of a press-bonded body for example. The surface pressure is preferably 4 MPa or greater, and more preferably 5 MPa or greater. The upper limit is not particularly limited and is 50 MPa or lower, for example.

The surface pressure is a sum of the pressure of carbon dioxide introduced into the system and the press pressure.

During the press-bonding in the step 1, the press duration may be appropriately selected in accordance with, for example, the type and amount of a base material and the adhesive to be used, and surface pressure and temperature during the press-bonding, and is preferably 0.2 seconds or longer, and more preferably a second or longer; and preferably 15 minutes or shorter, and more preferably 5 minutes or shorter.

In the step 1, a temperature at which the press-bonding is performed may be appropriately selected in accordance with the type and amount of a base material and the adhesive to be used, and the intended shape of a press-bonded body for example. By the present method, intended press-bonded bodies are obtainable without applying temperature. Thus, from the viewpoint for example that the effect as such is more remarkably exhibited, the temperature at which the press-bonding is performed is ordinarily 0° C. or higher, and preferably 20° C. or higher; and ordinarily 40° C. or lower, and preferably 30° C. or lower.

The step 1 may be performed in a hermetic container whose volume is reducible or may also be performed using an open system press device.

An example of the hermetic container is a container having an introduction unit for introducing liquid or gaseous carbon dioxide into the hermetic container, an exhaust unit for exhausting carbon dioxide, and a component such as a piston which can reduce the volume of the hermetic container to press a base material.

When an open system press device is used, object base materials can be processed in spots without using a large processing container covering the entirety of the object base materials. A press-bonded body is continuously producible for example by a method in which a base material is repeatedly pressed by feeding the base material which changes the position to be pressed or by a method in which a base material is pressed using rollers instead of pistons.

According to an embodiment of the present invention, a secondary processing for further press-bonding the press-bonded body obtained by the step 1 to another base material is also performable, which is impossible with a press-bonded body obtained by heat-sealing.

### EXAMPLES

Next, an embodiment of the present invention is described in further detail below with reference to, but not limited to, examples.

### Example 1

A base material was prepared by stamping out a circle with φ 19 from a non-woven fabric composed of PTFE nanofibers having an average fiber diameter of 900 nm (produced by ZEUS Industrial Products, Inc., basis weight: 24 g/m², thickness: 70 μm).

In addition, FFKM solutions having various regulated concentrations (0.5% by weight, 1% by weight, and 2% by weight) were prepared by dissolving FFKM (produced by 3M, product number: PFE-191TZ) in Fluorinert (produced by 3M, product number: PF-5060). The base material obtained above was immersed in the FFKM solution for 10 seconds and was removed from the solution, and the solvent (Fluorinert) was thereafter dried to give a base material with FFKM.

In a hermetically-closable container (caliber: φ 20 mm, the container described in JP 2018-099885 A) having a piston, a carbon dioxide introduction unit, and a carbon dioxide exhaust unit, 10 sheets of the obtained base material with FFKM which were superimposed on top of one another were laid and carbon dioxide equivalent to carbon dioxide under the vapor pressure thereof (cylinder pressure: 6 MPa) was introduced thereinto at room temperature (25° C.), the volume in the container was reduced by pushing the piston (while liquifying carbon dioxide) to apply a pressure with a load of 300 N or 1,000 N for 10 seconds in order to press-bond the 10 sheets of the base material. Thereafter carbon dioxide was instantly exhausted while maintaining the pressure, the pressure was subsequently relieved, and then a press-bonded body (φ 20 mm) was removed from the container.

### Peel Strength Test

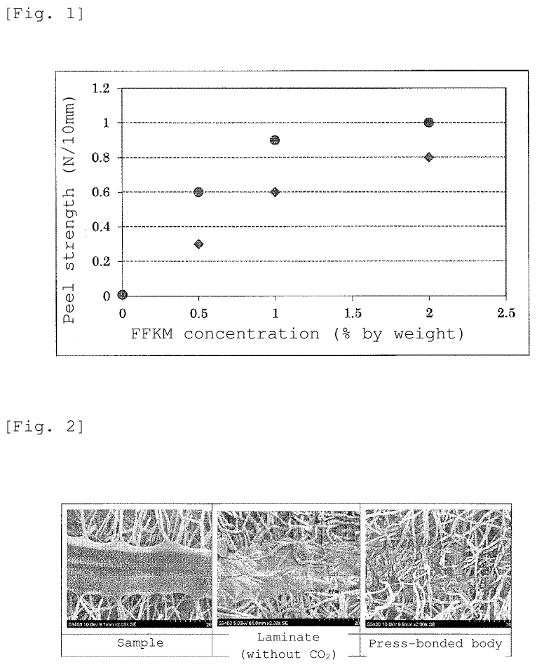

With respect to the mechanical properties of the obtained press-bonded body, the average peel strength (N/10 mm) of the press-bonded body in a displacement of 5 to 10 mm (5 to 10 seconds after tearing) when the press-bonded body was torn at a rate of 1 mm/s in the press-bonding direction (namely when a tensile load was applied in a direction perpendicular to the bonded surface) was measured with a universal tensile tester (EZ-test, produced by Shimadzu Corporation). The results are summarized in Table 1 and FIG. 1. In FIG. 1, the black circle represents the results obtained by applying a load of 1,000 N and the black diagonal square represents the results obtained by applying a load of 300 N.

As a control, a base material with FFKM was obtained in the same manner as described above except for immersing a base material in a 1% by weight FFKM solution, a laminate (without CO₂) was prepared using 10 sheets of the obtained base material with FFKM in the same manner as described in the above preparation of a press-bonded body except for introducing no carbon dioxide, and the peel strength of the laminate was measured in the same manner as described above. The results are summarized in Table 1.

As an additional control, a laminate (FFKM concentration: 0% by weight) was prepared in the same manner as described in the above preparation of a press-bonded body except for using 10 sheets of a base material before the immersion in the FFKM solution instead of the base material with FFKM, and the peel strength of the laminate was measured in the same manner as described above. The results are summarized in Table 1 and FIG. 1.

TABLE 1

| | Press force: | Press force: |
|---|---|---|
| | 300 N | 1000 N |
| Laminate | 0.05 N/10 mm | 0.05 N/10 mm |
| (FFKM concentration: 1% by weight, | | |
| without CO₂) | | |
| Laminate | 0.01 N/10 mm | 0.01 N/10 mm |
| (FFKM concentration: 0% by weight) | | |
| Press-bonded body | 0.3 N/10 mm | 0.6 N/10 mm |
| (FFKM concentration: 0.5% by weight) | | |
| Press-bonded body | 0.6 N/10 mm | 0.9 N/10 mm |
| (FFKM concentration: 1% by weight) | | |
| Press-bonded body | 0.8 N/10 mm | 1.0 N/10 mm |
| (FFKM concentration: 2% by weight) | | |

### Example 2

A base material was prepared by stamping out a circle with φ 19 from a non-woven fabric composed of PTFE nanofibers having an average fiber diameter of 900 nm (produced by ZEUS Industrial Products, Inc., basis weight: 24 g/m², thickness: 70 μm).

In addition, FKM solutions having various regulated concentrations (1% by weight and 2% by weight) were obtained by dissolving FKM (produced by Daikin Industries, Ltd., product number: G902) in methyl ethyl ketone (produced by Fujifilm Wako Pure Chemical Corporation). The base material obtained above was immersed in the FKM solution for 10 seconds and was removed from the solution, and the solvent (methyl ethyl ketone) was thereafter dried to give a base material with FKM.

A press-bonded body was prepared in the same manner as described in Example 1 except for using 10 sheets of the obtained base material with FKM, and the peel strength was measured. The results are summarized in Table 2.

As a control, a base material with FKM was obtained in the same manner as described above except for immersing the base material in a 1% by weight FKM solution, a laminate (without CO₂) was prepared using 10 sheets of the obtained base material with FKM in the same manner as described in the above preparation of a press-bonded body except for introducing no carbon dioxide, and the peel strength of the laminate was measured in the same manner as described above. The results are summarized in Table 2.

As an additional control, a laminate (FKM concentration: 0% by weight) was prepared in the same manner as described in the above preparation of a press-bonded body except for using 10 sheets of a base material before the immersion in the FKM solution instead of the base material with FKM, and the peel strength of the laminate was measured in the same manner as described above. The results are summarized in Table 2.

TABLE 2

| | Press force: | Press force: |
|---|---|---|
| | 300 N | 1000 N |
| Laminate | 0.05 N/10 mm | 0.05 N/10 mm |
| (FKM concentration: 1% by weight, | | |
| without CO₂) | | |
| Laminate | 0.01 N/10 mm | 0.01 N/10 mm |
| (FKM concentration: 0% by weight) | | |
| Press-bonded body | 0.28 N/10 mm | 0.85 N/10 mm |
| (FKM concentration: 1% by weight) | | |
| Press-bonded body | 0.60 N/10 mm | 0.65 N/10 mm |
| (FKM concentration: 2% by weight) | | |

### Example 3

A FFKM layer (line) having a width of approximately 10 to 20 μm was formed on a non-woven fabric composed of PTFE nanofibers (produced by ZEUS Industrial Products, Inc., basis weight: 24 g/m², thickness: 70 μm) using a solution obtained by dissolving FFKM (PFE-191TZ) in Fluorinert (produced by 3M, product number: FC-3283), and a circle with φ 19 was stamped from the obtained laminate to give a sample.

Ten sheets of the sample were prepared, superimposed on top of one another in the same direction (such that FFKM fibers of all the samples face upward), and were laid in a container. A press-bonded body was prepared in the same manner as described in Example 1 except for applying a load of 1,000 N.

As a control, a laminate (without CO₂) was prepared by applying a pressure with a load of 1,000 N to the 10 sheets of the sample in the same manner except for introducing no carbon dioxide.

With respect to the obtained press-bonded body and laminate (without CO₂), the structure of a surface on which a FFKM layer was formed, was observed using a SEM (S-3400N, produced by Hitachi High-Technologies Corporation—The same SEM was hereinafter used) with a 2000-fold magnification. The results are summarized in FIG. 2.

The left side of FIG. 2 is an SEM image of a surface on the side of which an FFKM layer was formed of a sample used, the center of FIG. 2 is an SEM image of a surface on the side of which an FFKM layer was formed of the obtained laminate (without CO₂), and the right side of FIG. 2 is an SEM image of a surface on the side of which an FFKM layer was formed of the obtained press-bonded body.

In the laminate (without CO₂), the FFKM fibers were simply compressed such that the FFKM layer was merely present on the non-woven fabric composed of PTFE nanofibers (the center of FIG. 2). In contrast, the press-bonded body appears to be in a state such that FFKM fibers were pushed (penetrated) into the non-woven fabric composed of PTFE nanofibers (the right side of FIG. 2).

### Example 4

In an FFKM solution obtained by dissolving FFKM (PFE-191TZ) in Fluorinert (PF-5060) so as to have an FFKM concentration of 1% by weight, 0.5 g of PFA staple fibers having an average fiber diameter of 60 μm were immersed and were thereafter removed from the solution, and the solvent was dried to give staple fibers with FFKM. With respect to the obtained staple fibers with FFKM, the adhesion of approximately 0.015 g of FFKM onto 0.5 g of the PFA staple fibers was confirmed by the dry weight method.

A press-bonded body was prepared in the same manner as described in Example 1 except for using approximately 0.515 g of the obtained staple fibers with FFKM instead of 10 sheets of the base material with FFKM and changing the load to 3,000 N.

As a control, a laminate (without CO₂) was prepared by applying a pressure with a load of 3,000 N to approximately 0.515 g of staple fibers with FFKM in the same manner except for introducing no carbon dioxide.

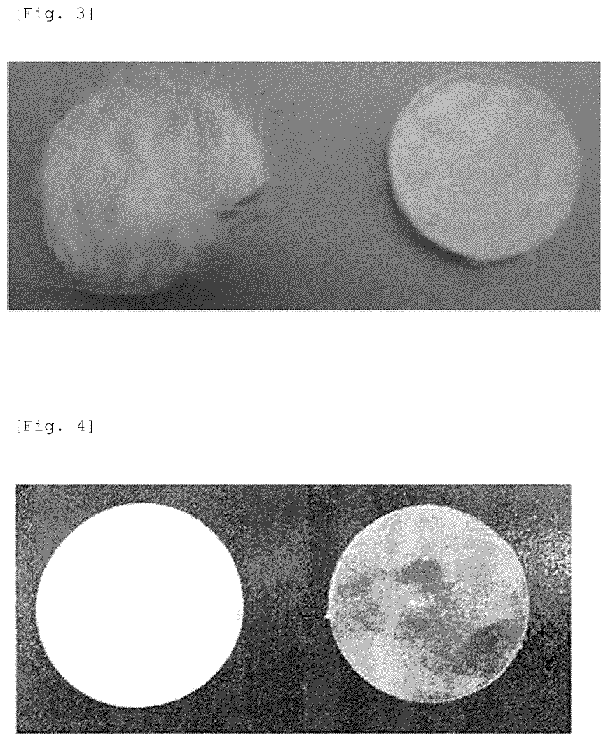

The photographs showing the appearance of the obtained press-bonded body and laminate (without CO₂) are shown in FIG. 3. In FIG. 3, the left side is the photograph showing the appearance of the laminate (without CO₂) and the right side is the photograph showing the appearance of the press-bonded body. When a pressure was applied without CO₂, a molding in an intended shape could not be achieved. In contrast, when press-bonding was performed using CO₂, a molding in an intended shape could be obtained and the shape could be maintained.

### Example 5

A press-bonded body was prepared in the same manner as described in Example 3 except for using a non-woven fabric composed of PTFE nanofibers (produced by ZEUS Industrial Products, Inc., basis weight: 24 g/m², thickness: 70 μm) having an average fiber diameter of 900 nm and being hydrophilized with PVA, instead of non-woven fabric composed of PTFE nanofibers.

The photograph showing the appearance of the obtained press-bonded body is shown on the left side of FIG. 4. The photograph showing the appearance of the obtained press-bonded body that was immersed in water and was thereafter removed from water is shown on the right side of FIG. 4.

Due to the hydrophilizing function of PVA, a phenomenon in which the press-bonded body absorbs water when being immersed in water was observed. With respect to the obtained press-bonded body, 10 sheets of the base material could be press-bonded while maintaining the hydrophilic function of the base material before the press-bonding.

### Example 6

An FFKM solution was prepared by dissolving FFKM (PFE-191TZ) in Fluorinert (PF-5060) such that the concentration of FFKM was 10% by weight, the FFKM solution was cast into a film shape with a doctor blade, and the solvent was thereafter volatilized to give an FFKM film (thickness: 50 μm).

A circle with φ 19 was stamped out from each of the obtained FFKM film and non-woven fabric composed of PTFE nanofibers (produced by ZEUS Industrial Products, Inc., basis weight: 24 g/m², thickness: 70 μm).

A press-bonded body was prepared in the same manner as described in Example 1 except for using the circles with φ 19 stamped out from the non-woven fabric sandwiching the circle with φ 19 stamped out from the FFKM film, instead of 10 sheets of the base material with FFKM superimposed on top of one another and applying a load of 1,000 N. A press-bonded body in an intended shape in a state such that part of the FFKM film was pushed into pores of the non-woven fabric composed of PTFE nanofibers could be formed.

In addition, the peel strength of the non-woven fabrics in the obtained press-bonded body was measured in the same manner as described in Example 1. The peel strength of 0.2 N/10 mm or grater was evaluated as O, and the peel strength of less than 0.2 N/10 mm was evaluated as X. The result is shown in Table 3.

### Comparative Example 6

A laminate was prepared in the same manner as described in Example 6 except for introducing no carbon dioxide. With respect to the obtained laminate, the adhesiveness between the non-woven fabrics was evaluated in the same manner as described in Example 6. The result is shown in Table 3.

### Example 7

An FFKM solution was prepared by dissolving FFKM (PFE-191TZ) in Fluorinert (PF-5060) such that the concentration of FFKM was 10% by weight and was cast into a film state, and the solvent was thereafter volatilized to give an FFKM film (thickness: 50 μm).

A circle with φ 19 was stamped out from each of the obtained FFKM film and an e-PTFE membrane (Advantec membrane filter T100A047A, produced by ADVANTEC TOYO KAISHA, Ltd.).

A press-bonded body was prepared in the same manner as described in Example 1 except for using the circles with φ 19 stamped out from the e-PTFE membrane sandwiching the circle with φ 19 stamped out from the FFKM film, instead of 10 sheets of the base material with FFKM superimposed on top of one another and applying a load of 1,000 N.

A press-bonded body in an intended shape in which the e-PTFE membranes were bonded to each other with sufficient strength could be formed. With respect to the obtained press-bonded body, the adhesiveness between the e-PTFE membranes was evaluated in the same manner as described in Example 6. The result is shown in Table 3.

### Comparative Example 7

A laminate was prepared in the same manner as described in Example 7 except for introducing no carbon dioxide. With respect to the obtained laminate, the adhesiveness between the e-PTFE membranes was evaluated in the same manner as described in Example 6. The result is shown in Table 3.

### Example 8

A press-bonded body was prepared in the same manner as described in Example 7 except for using, instead of the e-PTFE membrane, a membrane obtained by hydrophilizing the e-PTFE membrane in Example 7.

A press-bonded body in an intended shape in which the hydrophilized e-PTFE membranes were bonded to each other with sufficient strength was formed. The obtained press-bonded body was found to be formed while maintaining the hydrophilic function of the e-PTFE membrane before the press-bonding. With respect to the obtained press-bonded body, the adhesiveness between the hydrophilized e-PTFE membranes was evaluated in the same manner as described in Example 6. The result is shown in Table 3.

### Comparative Example 8

A laminate was prepared in the same manner as described in Example 8 except for introducing no carbon dioxide. With respect to the obtained laminate, the adhesiveness between the hydrophilized e-PTFE membranes was evaluated in the same manner as described in Example 6. The result is shown in Table 3.

### Example 9

An FFKM solution was prepared by dissolving FFKM (PFE-191TZ) in Fluorinert (PF-5060) such that the concentration of FFKM was 10% by weight, the FFKM solution was cast into a film shape, the solvent was thereafter volatilized, and a circle with φ 19 was stamped out to give an FFKM film (thickness: 50 μm).

A circle with φ 19 was stamped out from a non-woven fabric composed of PTFE nanofibers having an average fiber diameter of 900 nm (produced by ZEUS Industrial Products, Inc., basis weight: 24 g/m², thickness: 70 μm) to give a non-woven fabric base material. In addition, a circle with φ 19 was stamped out from an e-PTFE membrane (Advantec membrane filter T100A047A) to give an e-PTFE membrane base material.

A press-bonded body was prepared in the same manner as described in Example 1 except for using the obtained non-woven fabric base material and e-PTFE membrane base material sandwiching the circle with φ 19 stamped out from the FFKM film, instead of 10 sheets of the base material with FFKM superimposed on top of one another and applying a load of 1,000 N.

A press-bonded body in an intended shape in which the non-woven fabric base material and the e-PTFE membrane base material were bonded to each other with sufficient strength could be formed. With respect to the obtained press-bonded body, the adhesiveness between the non-woven fabric base material and the e-PTFE membrane base material was evaluated in the same manner as described in Example 6. The result is shown in Table 3.

### Comparative Example 9

A laminate was prepared in the same manner as described in Example 9 except for introducing no carbon dioxide. With respect to the obtained laminate, the adhesiveness between the non-woven fabric base material and the e-PTFE membrane base material was evaluated in the same manner as described in Example 6. The result is shown in Table 3.

### Example 10

An FFKM solution was prepared by dissolving FFKM (PFE-191TZ) in Fluorinert (PF-5060) such that the concentration of FFKM was 10% by weight, the FFKM solution was cast with a doctor blade on a roughened surface of a PTFE film [a film in which a surface of VALFLON #7900 (thickness: 50 μm) produced by Valqua, Ltd., was roughened], and the solvent was thereafter volatilized to give a laminated film (thickness: 65 μm).

A circle with φ 19 was stamped out from each of the laminated film and a non-woven fabric composed of PTFE nanofibers (produced by ZEUS Industrial Products, Inc., basis weight: 24 g/m², thickness: 70 μm) and the circles were superimposed on top of one another such that the non-woven fabric was in contact with FFKM. A press-bonded body was prepared in the same manner as described in Example 1 except for using the thus-obtained laminate instead of 10 sheets of the base material with FFKM superimposed on top of one another and applying a load of 300 N.

A press-bonded body in an intended shape in which the PTFE film and the non-woven fabric were bonded to each other with sufficient strength could be formed. With respect to the obtained press-bonded body, the adhesiveness between the PTFE film and the non-woven fabric was evaluated in the same manner as described in Example 6. The result is shown in Table 3.

### Comparative Example 10

A laminate was prepared in the same manner as described in Example 10 except for introducing no carbon dioxide. With respect to the obtained laminate, the adhesiveness between the PTFE film and the non-woven fabric was evaluated in the same manner as described in Example 6. The result is shown in Table 3.

TABLE 3

| | | Adhesive | | CAPC conditions | | Adhesiveness |
|---|---|---|---|---|---|---|
| | Base material 1 | layer | Base material 2 | Press force | CO₂ | evaluation |
| Example 6 | PTFE non-woven | FFKM film | PTFE non-woven | 1000 N | with CO₂ | ◯ |
| Comparative | fabric | | fabric | 1000 N | without | X |
| example 6 | | | | | CO₂ | |
| Example 7 | e-PTFE | FFKM film | e-PTFE | 1000 N | with CO₂ | ◯ |
| Comparative | | | | 1000 N | without | X |
| example 7 | | | | | CO₂ | |
| Example 8 | e-PTFE | FFKM film | e-PTFE | 1000 N | with CO₂ | ◯ |
| Comparative | (hydrophilized) | | (hydrophilized) | 1000 N | without | X |
| example 8 | | | | | CO₂ | |
| Example 9 | PTFE non-woven | FFKM film | e-PTFE | 1000 N | with CO₂ | ◯ |
| Comparative | fabric | | | 1000 N | without | X |
| example 9 | | | | | CO₂ | |
| Example 10 | PTFE film | FFKM film | PTFE non-woven | 300 N | with CO₂ | ◯ |
| Comparative | | | fabric | 300 N | without | X |
| example 10 | | | | | CO₂ | |

### Example 11

A press-bonded body was prepared in the same manner as described in Example 6 except for using a non-woven fabric composed of a liquid crystal polymer (produced by Kuraray, Co., Ltd., VECRUS MBBK11F) instead of the non-woven fabric composed of PTFE nanofibers and applying a load of 300 N in Example 6. The adhesiveness of the non-woven fabrics in the obtained press-bonded body was evaluated in the same manner as described in Example 6. The result is shown in Table 4.

### Comparative Example 11

A laminate was prepared in the same manner as described in Example 11 except for introducing no carbon dioxide. The adhesiveness between the non-woven fabrics in the obtained laminate was evaluated in the same manner as described in Example 6. The result is shown in Table 4.

### Example 12

A press-bonded body was prepared in the same manner as described in Example 6 except for using a glass fiber cloth (produced by Sakai Sangyo K.K., ATG26100-1) instead of the non-woven fabric composed of PTFE nanofibers and applying a load of 300 N in Example 6. The adhesiveness between the cloths in the obtained press-bonded body was evaluated in the same manner as described in Example 6. The result is shown in Table 4.

### Comparative Example 12

A laminate was prepared in the same manner as described in Example 12 except for introducing no carbon dioxide. The adhesiveness between the cloths in the obtained laminate was evaluated in the same manner as described in Example 6. The result is shown in Table 4.

### Example 13

A press-bonded body was prepared in the same manner as described in Example 6 except for using a carbon fiber cloth (produced by ElectroChem, Inc., EC-CC1-060) instead of the non-woven fabric composed of PTFE nanofibers in Example 6 and applying a load of 300 N. The adhesiveness between the cloths in the obtained press-bonded body was evaluated in the same manner as described in Example 6. The result is shown in Table 4.

### Comparative Example 13

A laminate was prepared in the same manner as described in Example 13 except for introducing no carbon dioxide. The adhesiveness between the cloths in the obtained laminate was evaluated in the same manner as described in Example 6. The result is shown in Table 4.

### Example 14

A press-bonded body was prepared in the same manner as described in Example 6 except for using a stainless steel fiber cloth (produced by NBC Meshtec Inc., SUS304 mesh 400-023) instead of the non-woven fabric composed of PTFE nanofibers and applying a load of 300 N in Example 6. The adhesiveness between the cloths in the obtained press-bonded body was evaluated in the same manner as described in Example 6. The result is shown in Table 4.

### Comparative Example 14

A laminate was prepared in the same manner as described in Example 14 except for introducing no carbon dioxide. The adhesiveness between the cloths in the obtained laminate was evaluated in the same manner as described in Example 6. The result is shown in Table 4.

TABLE 4

| | | Adhesive | | CAPC conditions | | Adhesiveness |
|---|---|---|---|---|---|---|
| | Base material 1 | layer | Base material 2 | Press force | CO₂ | evaluation |
| Example 11 | Liquid crystal | FFKM film | Liquid crystal | 300 N | with CO₂ | ◯ |
| Comparative | polymer non- | | polymer non- | 300 N | without | X |
| Example 11 | woven fabric | | woven fabric | | CO₂ | |
| Example 12 | Glass cloth | FFKM film | Glass cloth | 300 N | with CO₂ | ◯ |
| Comparative | | | | 300 N | without | X |
| Example 12 | | | | | CO₂ | |
| Example 13 | Carbon cloth | FFKM film | Carbon cloth | 300 N | with CO₂ | ◯ |
| Comparative | | | | 300 N | without | X |
| Example 13 | | | | | CO₂ | |
| Example 14 | Stainless steel | FFKM film | Stainless steel | 300 N | with CO₂ | ◯ |
| Comparative | cloth | | cloth | 300 N | without | X |
| Example 14 | | | | | CO₂ | |

1. An adhesive comprising a fluoroelastomer for bonding base materials in the presence of carbon dioxide in a liquid state, a gas-liquid mixture state, or a nearly liquid state.

2. The adhesive according to claim 1 for bonding at a temperature lower than a temperature at which the adhesive melts.

3. The adhesive according to claim 1, wherein the fluoroelastomer is at least one selected from tetrafluoroethylene-perfluorovinylether copolymers and fluorine rubber.

4. A bonded body wherein two or more base materials are bonded to each other with the adhesive according to claim 1.

5. The bonded body according to claim 4, wherein at least one of the base materials is a non-woven fabric, a woven fabric, a porous membrane, or a fiber.

6. A method for producing a press-bonded body, comprising a step 1 of
press-bonding two or more base materials
in the presence of an adhesive comprising a fluoroelastomer, and
carbon dioxide in a liquid state, a gas-liquid mixture state, or a nearly liquid state.

7. The method for producing a press-bonded body according to claim 6, wherein the step 1 is
a step 1a in which a laminate in which an adhesive layer obtained from the adhesive is arranged between the base materials is brought into contact with liquid or gaseous carbon dioxide and is pressurized, or
a step 1b in which a contact body in which the base materials are brought into contact with the adhesive or a dried body in which said contact body is dried is brought into contact with liquid or gaseous carbon dioxide and is pressurized.
